(19) United States
(12) Patent Application Publication
(10) Pub. No.: US 2012/0130741 A1
(43) Pub. Date: May 24, 2012

(54) INTEGRATED PATIENT INFORMATION VIEWER INTERFACE

(75) Inventors: Michael Sparandara, San Francisco, CA (US); Nicholas Leonard, Wildwood, MO (US); Michael Lin, Rowland Heights, CA (US); Anna Ostberg, Los Altos, CA (US); Averie Youna Yang, Dresher, PA (US)

(73) Assignee: General Electric Company, Schenectady, NY (US)

(21) Appl. No.: 12/954,101

(22) Filed: Nov. 24, 2010

(51) Int. Cl. G06Q 50/00; G06Q 10/00; G06Q 90/00

(52) U.S. Cl. 705/3; 705/500

(57) ABSTRACT

An example an integrated patient information viewer includes a header portion to be arranged to convey identification information for a patient to a user at a glance; a timeline arranged to provide a longitudinal visualization of a patient's record; a user viewspace to display a chronological view of patient encounters and associated documents; and a document workspace to store one or more patient documents based on user placement. The timeline is to be navigable to display different portions of the patient's record based on user input, is to provide visual indicators of clusters of patient encounters, and is to expand to provide further detail on a patient encounter based on user input. The viewspace is to enable a user to one or more documents for display and comparison. The one or more patient documents are to be retrievable for display and comparison in the user viewspace.

### FIELD

The present invention generally relates to a healthcare user interface. In particular, the present invention relates to systems, methods, and apparatus for integrated patient information viewing.

### BACKGROUND

A clinical or healthcare environment is a crowded, demanding environment that would benefit from organization and improved ease of use of imaging systems, data storage systems, and other equipment used in the healthcare environment. A healthcare environment, such as a hospital or clinic, encompasses a large array of professionals, patients, equipment and computerized information systems. Personnel in a healthcare facility must manage a plurality of patients, systems, and tasks to provide quality service to patients. Healthcare personnel may encounter many difficulties or obstacles in their workflow.

Healthcare has become centered around electronic data and records management. Healthcare environments, such as hospitals or clinics, include information systems, such as healthcare information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information for a particular information system may be centrally stored or divided at a plurality of locations. Healthcare practitioners may desire to access patient information or other information at various points in a healthcare workflow. For example, during an imaging scan of a patient, medical personnel may access patient information, such as a patient exam order, that are stored in a medical information system. Alternatively, medical personnel may enter new information, such as history, diagnostic, and/or treatment information, into a medical information system during an imaging scan.

Different clinical departments and different clinical systems gather patient information in different ways and in different forms and often separately store that information. The information must then be retrieved and viewed from several disparate systems.

Current information and management systems do not offer interconnection and flexibility. Current clinical information systems are typically modified manually by programmers for particular users. Many components of a patient care or practice management workflow are paper-based or not present at all. Current systems do not provide a central system by which a user may access and interrelate patient information, resource information, orders, and results. Many third party vendors providing a variety of solutions also present difficulties regarding interoperability and connectivity.

Currently, relevant patient information for a patient's entire lifetime exists in a number of formats that include paper, folders and disparate information systems from a variety of vendors and a variety of healthcare providers. Current systems cannot aggregate this information effectively. Additionally, current systems cannot display this information at one time so that healthcare providers have the ability to interpret a patient's complete medical history when assessing and diagnosing illnesses. Providers are rarely able to see the full history of a patient. More commonly, providers have only the information that they have gathered or that they have received in response to questions asked of the patient in a clinical setting. Key decisions are made with the limited knowledge available to the provider at the point at which the provider is making a decision.

### BRIEF SUMMARY

Certain examples provide systems, methods, and apparatus to provide an integrated view of patient information.

Certain examples provide an integrated patient information viewer system. The system includes a header portion to be arranged to convey identification information for a patient to a user at a glance. The system includes a timeline arranged to provide a longitudinal visualization of a patient's record. The timeline is to be navigable to display different portions of the patient's record based on user input. The timeline is to provide visual indicators of clusters of patient encounters. The timeline is to expand to provide further detail on a patient encounter based on user input. The system includes a user viewspace to display a chronological view of patient encounters and associated documents. The viewspace is to enable a user to one or more documents for display and comparison. The system includes a document workspace to store one or more patient documents based on user placement. The one or more patient documents are to be retrievable for display and comparison in the user viewspace. A change in information presented in one of the timeline, the user viewspace, or the document workspace is to affect a corresponding change in information presented in the other of the timeline, the user viewspace, or the document viewspace.

Certain examples provide a tangible computer readable storage medium including executable program instructions which, when executed by a computer processor, cause the computer to implement a patient information viewer. The viewer includes a header portion to be arranged to convey identification information for a patient to a user at a glance. The viewer includes a timeline arranged to provide a longitudinal visualization of a patient's record. The timeline is to be navigable to display different portions of the patient's record based on user input. The timeline is to provide visual indicators of clusters of patient encounters. The timeline is to expand to provide further detail on a patient encounter based on user input. The viewer includes a user viewspace to display a chronological view of patient encounters and associated documents. The viewspace is to enable a user to one or more documents for display and comparison. The viewer includes a document workspace to store one or more patient documents based on user placement. The one or more patient documents are to be retrievable for display and comparison in the user viewspace. A change in information presented in one of the timeline, the user viewspace, or the document workspace is to affect a corresponding change in information presented in the other of the timeline, the user viewspace, or the document viewspace.

Certain examples provide a computer-implemented method for providing an integrated patient information view to a user. The method includes authenticating a user for access to healthcare records for a selected patient. The method includes providing a plurality of records for the patient to the user via an integrated patient information viewer. The patient information viewer includes a header portion to be arranged to convey identification information for a patient to a user at a glance. The viewer includes a timeline arranged to provide a longitudinal visualization of a patient's record. The timeline is to be navigable to display different portions of the patient's record based on user input. The timeline is to provide visual indicators of clusters of patient encounters. The timeline is to expand to provide further detail on a patient encounter based on user input. The viewer includes a user viewspace to display a chronological view of patient encounters and associated documents. The viewspace is to enable a user to one or more documents for display and comparison. The viewer includes a document workspace to store one or more patient documents based on user placement. The one or more patient documents are to be retrievable for display and comparison in the user viewspace. A change in information presented in one of the timeline, the user viewspace, or the document workspace is to affect a corresponding change in information presented in the other of the timeline, the user viewspace, or the document viewspace. The method includes accepting user selection to display one or more records in the user viewspace based on user input from at least one of the timeline, user viewspace, and document workspace.

### BRIEF DESCRIPTION OF SEVERAL VIEWS OF THE DRAWINGS

FIG. 1 illustrates an example patient information viewer providing an integrated view of patient information to a user.

FIG. 2 illustrates an example dashboard displayed via a patient information viewer.

FIG. 3 illustrates an example comparison view comparing two documents side by side in a patient information viewer.

FIG. 4 illustrates an example patient timeline view in a patient information viewer.

FIG. 5 illustrates example document arrangement via a document workspace.

FIG. 6 illustrates an example document comparison via a patient document viewspace.

FIG. 7 shows an example advanced filter search.

FIG. 8 illustrates an example advanced filter configuration.

FIG. 9 illustrates example abbreviated and expanded patient header views.

FIG. 10 shows an example mobile patient information viewer.

FIG. 11 illustrates a flow diagram for an example method for integrated patient information viewing.

FIG. 12 depicts a patient information system diagram illustrating relationships between different interface screens and features available in an example patient information viewer.

FIG. 13 depicts interactions that can be performed in a history view.

FIG. 14 depicts interactions that can be performed in a document view.

FIG. 15 is a block diagram of an example processor system that may be used to implement systems, apparatus, and methods described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EXAMPLES

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, in an embodiment, at least one of the elements is hereby expressly defined to include a tangible medium such as a memory, DVD, CD, Blu-ray, etc., storing the software and/or firmware.

Certain examples provide clinical documentation for a patient in an integrated user interface. Certain examples enable a patient's medical history to be displayed and edited by the user. A user can view a patient's information at varying levels of granularity depending upon the detail desired, for example. From a high level overall vantage point, the user may navigate to any specific item in the patient's history by using a navigational cursor, mouse click, touch screen, voice command, gaze tracking, etc. The user can drill down in a timeline, document history, workspace, etc., to view specific lab reports, physical exam notes, images, procedures, etc. In certain examples, a user can navigate a complete set of patient healthcare data via a unified interface.

A patient electronic medical record (EMR), electronic health record (EHR), and/or other record include a medical history for a patient and include data with time stamps (or times and dates at which data was collected or entered). Types of data can include test name, test result, imaging acquisition, medical visit (e.g., hospital, office, clinic, etc.), medical problem, caregiver encounter, medical procedure, symptom, biological analysis, finding, medication, acquisition, etc. These types/categories of data can each be represented by a symbol on a common and/or individual timeline for each event of the data occurrence, for example.

In certain examples, patient data can be presented visually via a timeline including one or more symbols representing each patient encounter. A patient encounter can include any test, visit, or other encounter with any physician, nurse, radiologist, image technician or other caregiver, for example. With many patient encounters, the timeline can become too cluttered rendering it difficult to view individual data items and visualize associations between data. Data can be associated in a number of ways, such as by patient encounter (e.g., office/hospital visit/stay), time/date range, problem (e.g., diabetes, heart disease, broken bone, etc.), procedure (e.g., surgery, series of lab tests, etc.), collecting/entering hospital/clinic/caregiver, etc.

In certain examples, a patient medical record includes aggregated information from a plurality of information systems under a common patient context. Information systems may include a radiology information system (RIS), a picture archiving and communication system (PACS), Computer Physician Order Entry (CPOE), an electronic medical record (EMR), Clinical Information System (CIS), Cardiovascular Information System (CVIS), Library Information System (LIS), and/or other healthcare information system (HIS), for example. An integrated user interface facilitating access to the patient record can include a context manager, such as a clinical context object workgroup (CCOW) context manager and/or other rules-based context manager. Components can communicate via wired and/or wireless connections on one or more processing units, such as computers, medical systems, storage devices, custom processors, and/or other processing units. Components can be implemented separately and/or integrated in various forms in hardware, software and/or firmware, for example.

Information for a particular patient can be extracted and/or linked from one or more information systems for presentation to a user via a patient timeline and associated information viewer, for example. In certain examples, information retrieval, display and/or processing settings, for example, can be customized according to a particular user or type of user. Retrieval, aggregation, display and/or processing of information can be based on rules, preferences, and/or other settings, for example. Rules, preferences, settings, etc. can be generated automatically based on preset parameters and/or observed data, for example. Rules, preferences, settings, etc., can be created by a system administrator or other user, for example. Rules, preferences, settings, etc., also can be manually and/or automatically adapted based on user and/or automated system experiences, for example.

In certain examples, a patient record provides identification information, allergy and/or ailment information, history information, orders, medications, progress notes, flowsheets, labs, images, monitors, summary, administrative information, and/or other information, for example. The patient record can include a list of tasks for a healthcare practitioner and/or the patient, for example. The patient record can also identify a care provider and/or a location of the patient, for example.

In certain examples, an indication can be given of, for example, normal results, abnormal results, and/or critical results. For example, the indication can be graphical, such as an icon. The user can select the indicator to obtain more information. For example, the user can click on an icon to see details as to why a result was abnormal. In certain examples, the user may be able to view only certain types of results. For example, the user may only be eligible to and/or may only select to view critical results.

In certain examples, filters and/or rules can be provided for application to one or more views and/or categories. Ranges, such as values or dates, can be specified for data. Default views, categories, filters, rules, and/or ranges can be provided. In certain examples, default values can be modified by a user and/or based on operating conditions. In certain examples, new views, categories, filters, rules, ranges, etc., can be created by a user.

For example, a filter can be used to filter medical results data presented to a user according to one or more variables or parameters. For example, when a filter is selected by a user, a modification routine applies the filter to the results displayed to the user in the current view by removing from display all medical results that do not fall within the filter. For example, a variable/parameter can include one or more of a type (or item) and/or range of laboratory test results, vital sign measurements, fluids administered to a patient, and/or fluids measured from a patient. A variable/parameter can include text from notes, laboratory reports, examination reports, one or more captions to a laboratory test result, vital sign measurement, and/or fluids administered to/measured from a patient, an order for a laboratory test, treatment and/or prescription, and/or a name, for example. By specifying one or more limits on one or more variables and/or one or more restricting parameters, a user can create one or more filters to be applied to results presented in a results window.

In certain examples, an integrated user interface viewer is in communication with one or more applications and/or information systems. The integrated user interface interacts with individual application(s) and/or system(s) and masks or hides the individual application(s) and/or system(s) from a user. That is, the user sees and interacts with the integrated user interface viewer rather than with interfaces for individual connected application(s) and/or system(s), for example. A user can be authenticated via the integrated user interface, and that authentication can propagate throughout the connected application(s) and/or system(s), for example.

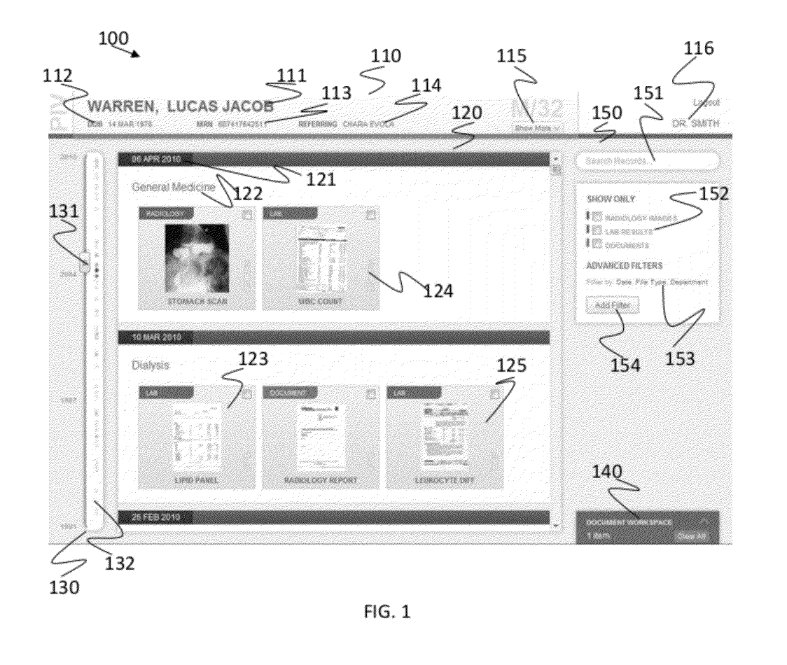

FIG. 1 illustrates an example patient information viewer (PIV) 100 providing an integrated view of patient information to a user. In certain examples, the PIV 100 is a Cross-enterprise Document Sharing (XDS) consumer to query and receive information from a plurality of sources and provide a user with one point of view for all patient data. The PIV 100 combines medical-ologies (e.g., oncology, ophthalmology, pharmacology, neurology, physiology, etc.) and provides them in a single view of the user. Using the single integrated view, for example, a physician user can review all available information for a patient.

The PIV 100 depicted in the example of FIG. 1 includes a header 110, a patient information viewspace or dashboard 120, a timeline 130, a document workspace 140, and a filter 150. In the example of FIG. 1, the header 110 includes patient information, provider information, and/or other identifying and/or administrative information regarding the patient information shown via the viewer 100. Header 110 information can include a patient name 111, date of birth 112, patient and/or record number 113, referring clinician 114, etc. In certain examples, certain information (e.g., most important and/or most relevant information) can be shown and other information (e.g., less important information) can be hidden but be accessible via an option such as a show more button/option 115.

Using the header 110, a user (e.g., a physician) can easily identify which patient he/she is currently reviewing and extract certain demographic information. Rather than including a cluttered header, the header can be collapsed and expanded depending upon information of interest to the user.

The header 110 of the example PIV 100 is designed to provide the right amount of patient information while preserving valuable screen real estate for the more frequently used components. In certain examples, the header 110 is constant and consistent throughout the application, and provides an expanding drop-down view for additional patient information.

In the example of FIG. 1, the patient information viewspace 120 includes one or more items of patient information. The information provided in the viewspace 120 can be divided or separated based on one or more criterion, for example. The viewspace 120 can be separated by date 121, department/unit 122, and/or other criterion, for example. As shown in the example of FIG. 1, a user can select from among available documents in the viewspace 120 (e.g., within each date 121 and/or department 122 in the viewspace 120). In certain examples, upon selection of a document, the document appears as a preview in the viewer 100 (e.g., as a preview in the right side of the viewspace 120 and/or the document workspace 140). For example, a user can select a document from the document workspace 140 to hide the document or to show the document in the viewspace 120. A user can drag and drop one or more documents in the viewspace 120, for example (e.g., one document, two by two, four by four, etc.). Documents available for viewing can include image(s) 123, protocol-compliant text document(s) 124 (e.g., DICOM-compliant reports, etc.), scanned document(s) 125 (e.g., PDFs), etc.

In certain examples, the viewspace 120 includes a dashboard, which provides an at-a-glance view of patient status, and/or a history view, which provides historical documents related to the patient being reviewed. In an example dashboard, patient data is organized by recency and/or by its relation to the patient's current complaint. The dashboard can provide a user with quick access to vitals, images, and labs, for example.

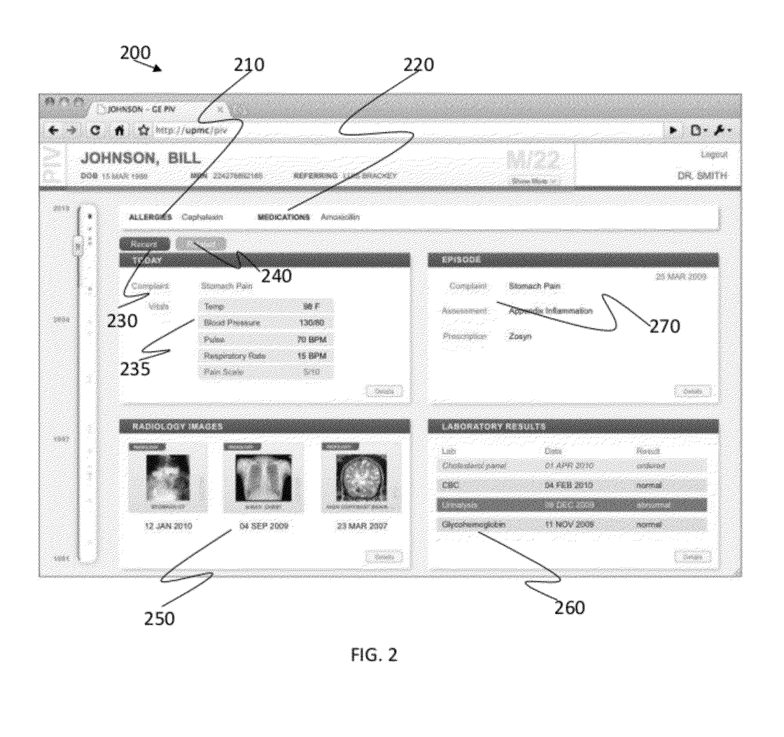

For example, FIG. 2 illustrates an example dashboard 200 including allergy information 210, medication information 220, recent complaint 230 including vitals 235, related complaint 240, related radiology image(s) 250, lab result(s) 260, and episode summary information 270.

The history view in the viewspace 120 presents thumbnails of radiology images, lab results and other documents in a large pane in the middle of the screen, for example. This is the central location for doctors to quickly scan patient information and select documents to view in higher resolution, for example.

As illustrated in FIG. 1, the timeline 130 indicates a range of information available for the patient record(s) being reviewed. The timeline 130 of the example of FIG. 1 includes a scroll bar 131 to allow the user to navigate along the timeline 130. One or more indicators 132 indicate an episode/event occurred providing some data at a particular date/time, for example. When a user selects a particular row/date, a color and/or icon indicator 312 indicates a particular document/department type. The indicator 132 can also include a number indicating a number of document(s) for that department for that date. A user can select (e.g., click on) a date entry to display the document(s) for that date and/or department (e.g., in the document viewspace 120). Selecting a document 123-125 in the viewspace 120 can open the document itself (e.g., in the viewspace 120).

The document view displays any clicked history item in a clutter-free built-in viewer. Two items can be viewed side-by-side by dragging an item from the document workspace 140 onto the viewer 120, for example. A toolset can be included to reduce application switching, for example.

The example timeline 130 provides a concise, glanceable summary of all records for any given patient. Using the timeline 130, a doctor and/or other practitioner can intuitively navigate through hundreds of patient records in seconds, and skip to any record with just one click.

The timeline 130 is one of the primary navigational tools of the PIV interface 100. By displaying a longitudinal view of a patient's visits, user can get a sense for how often a patient has received care and also can select a visit from this view to access the full notes and images associated with the visit. Using the timeline 130, a user can easily navigate to specific events. A user can easily find a specific date, and easily glance at data, allowing doctors to skim through years of medical history at high-level detail, for example.

A typical display affords more horizontal real estate than vertical real estate. Valuable vertical space is often used by a user's browser and other operating system components. Additionally, application toolbars and header bars further reduce the amount of space. In practice, a typical web application may have as few as 500 pixels of usable vertical body space. By contrast, the usable horizontal space is nearly double that.

The example timeline 130 avoids taking up additional vertical space in representing recent versus old events, showing detail for tightly clustered events versus sparsely distributed ones, and showing key information in a glanceable fashion, while remaining user friendly.

In certain examples, in order to present relevant information to users (e.g., physicians), episodic categorization of symptoms for patient's visits is integrated in to the timeline 130. Through the use of a drop-down list, for example, the user can select a specific episode to view. The timeline 130 can then be filtered to only show visits pertaining to the selected episode.

The example PIV 100 shown in FIG. 1 also includes a search/filter 150. The filter 150 includes a search box 151, which allows a user to type one or more words or phrases to filter and/or identify one or more patient records/documents. In certain examples, a user can start typing in the search box 151, and the PIV 100 suggests filters for the user based on the entered term(s)/phrase(s). A user can select a filter to filter by content 152 (e.g., radiology images, documents, lab results, etc.), and documents shown for the patient and date are automatically filtered. One or more filters can be selected, for example. The PIV 100 can include one or more pre-defined filters, including content filters 152, advanced filters (e.g., date, file type, department, etc.). In some examples, a user can define custom filters, for example. A user can apply filter(s) to the retrieved documents 154. A user can go back and remove filters to obtain an expanded data set, for example.

Advanced filters allow the user to narrow down the patient data with ease. Filtering can be performed on many different criteria, and can stack up to create extremely precise results. Additionally, a search box allows the user to quickly enter search terms to be added to the active filters.

Filtering is useful when presenting relevant information to doctors, for example. Using the example filter 150, users have the ability to filter data by one or more criterion including department, type of document, and related episodes. By filtering information presented, the viewer 100 can help users from being overwhelmed by the amount of information available to them. Filtering can help ensure that important and relevant information is not buried among trivial documents about colds or routine check-ups. By filtering this information along a number of dimensions, doctors should be able to locate documents more quickly, especially for patients with long or complicated medical histories, for example.

In certain examples, once the filter button is pressed, three filter tabs—categorized departments, departments A-Z, and episode—are brought up as well as three checkboxes—radiology scans, lab results, and scanned documents. These three checkboxes represent the major items that are looked at most frequently by doctors. In the “categorized departments” filter tab checkboxes of departments that are sorted by relation are displayed. In the “Departments A-Z” filter tab, checkboxes of the departments in alphabetical order are displayed as well as a search bar in the case that the doctor knows which department (s)he is looking for. The episode tab also has checkboxes for episodes that the doctor can use to filter by, as well as a search bar.

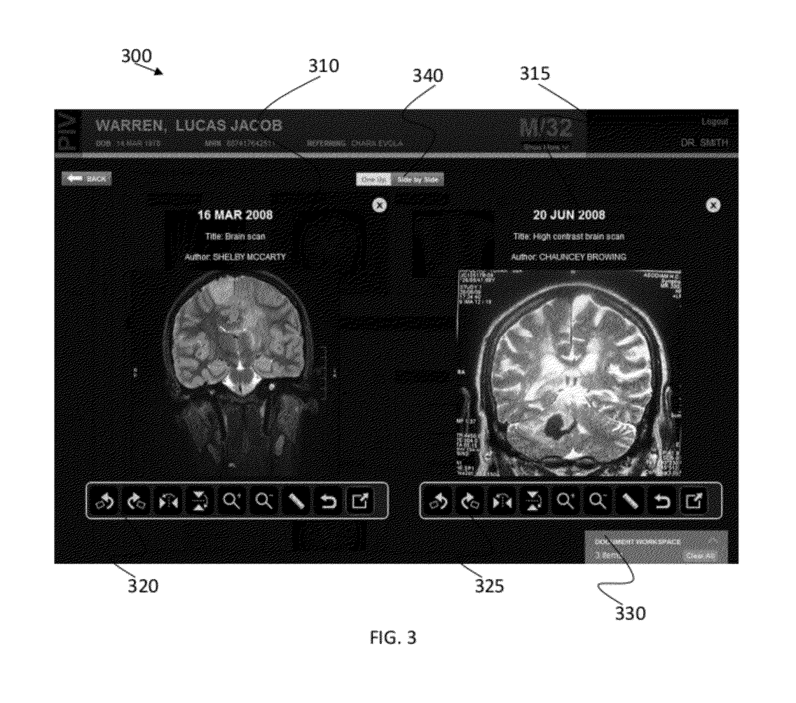

FIG. 3 illustrates an example comparison view 300 comparing two documents 310, 315 side by side in a PIV 300. As shown in the example of FIG. 3, each document (e.g., image) 310, 315 displayed in the PIV 300 includes an associated set of tools 320, 325 for viewing and manipulation of the documents 310, 315, launch external apps, etc. The documents 310, 315 can be selected (e.g., dragged and dropped) from a document workspace 330 and can be displayed in the viewer 300 individually, side-by-side, etc. 340.

Using the PIV 100, 300, a user can select and view images, documents, and/or other information by selecting one or more documents/images/etc. for viewing from one or more sections of the PIV 100, 300. User can compare different types of documents in order to form a better diagnosis, for example.

In certain examples, the document view 300 can be presented in darker colors to help prevent visual distraction when viewing documents. The header information adapts to the darker color scheme to allow physicians continual access to the patient's information and as a reminder of whose document they are viewing, for example.

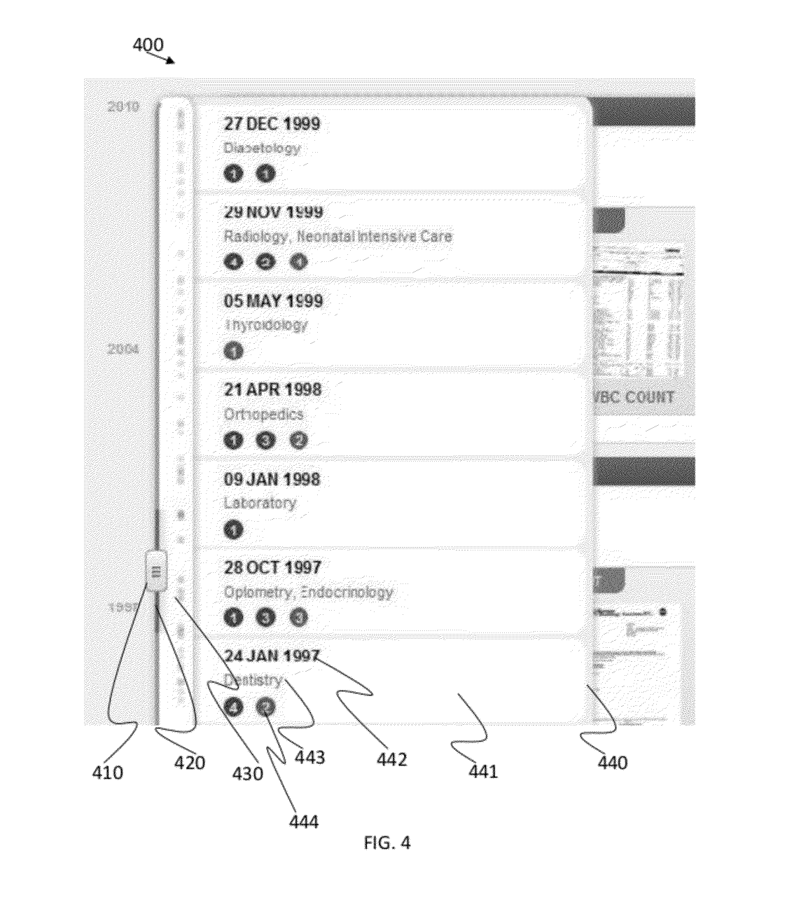

FIG. 4 illustrates an example patient timeline 400 view in a patient information viewer. The timeline 400 of the example of FIG. 4 includes a scroll thumb or indicator 410, which allows a user to move along the timeline 400 and change the associated information 430, 440 shown to the right in the timeline view 400. As shown in the example of FIG. 4, a scroll bar or line 420 indicates a subset or range of dates and/or other timeline entries shown on the summary portion 440 of the timeline 400. Dots and/or other indicators 430 highlight information available along the timeline 400 for the patient. Indicators 430 falling within the range specified by the scroll line 420 are highlighted for the user, for example. As depicted in the example of FIG. 4, indicators 430 within the scroll bar 420 range are provided in further detail in the form of summary records 440 in the timeline view 400.

As shown in FIG. 4, the left side of the timeline 400 displays an overview of all the activity in a patient record. Year labels run along the left side and small semi-transparent circles mark individual events inside the bar. When a user hovers over the main timeline, the right side detail pane slides into view, for example.

As shown in the example of FIG. 4, a user accesses the timeline 400 of the PIV. By moving the thumb 410 on the left side of the timeline 400, he/she can change the information that is shown on the right side 440. The dots 430 corresponding to the highlighted visits 420 also turn blue. Additionally, the designated blue area 420 scales automatically based on the density of results. The thumb 410 controls the selected timeline area by scrolling it up and down. In addition to moving the thumb 410, the user can also click or scroll with the mouse-wheel to move the selected area, for example. Moving the thumb 410 changes what indicators are highlighted (e.g., marked in blue), as well as the detailed view 440 on the right.

The selected area is marked by the scroll line 420 (e.g., a blue line). The scroll line 420 can be turned on and off based on user preference and/or an amount of available information for the patient, for example. The selected area encompassed by the scroll line 420 can dynamically determined based on clustering of events, and can be configured to always show the maximum displayable amount on the right side 440, for example. In certain examples, the details view 440 slides out from the timeline date bar and shows a “zoomed-in” table view of the patient record. Clicking on a row scrolls the history view 120 to the selected record, for example.

On the right side 440 of the timeline 400, he/she can see summary information 440 for each applicable encounter 441, including date 442, department 443, and number and type of documents 444 (e.g., with a color and/or shape indicating type, such as purple representing radiology images, pink representing lab results, and green representing documents). In certain examples, color-coding and/or other formatting of item markers is consistent throughout the application, including the labels on document thumbnails and in the filters. A number in the indicator 444 indicates a number of a certain type of document available with that encounter/record. The user locates an entry for a date of interest and notices that it is in the Orthopedics department, for example, and includes two documents. By selecting an entry 441, corresponding document thumbnail(s) are displayed in the viewspace, such as the viewspace 120 illustrated in FIG. 1 and discussed above.

Using the PIV 100 and its viewspace 120, encounters can be presented in a modular view, where documents are represented as thumbnails to provide a preview for physicians. To make documents easier to find, they can be organized by the date of the encounter first and then sorted by their originating departments, for example. A chronological organization also maintains a navigational relationship with the timeline.

As shown in the example viewspace 120 of FIG. 1, each record/document includes an indicator of the record's content (e.g., document, radiology image, lab result, etc.). Additionally, each record in the example 120 includes a label for document file type (e.g., ultrasound report, discharge summary, etc.) and document name. A checkbox in the example allows the user to select one or more records. Other glanceable visual indicators, such as a strip of color on the document thumbnail, help physicians to distinguish whether the document is one of three content types: radiology image, lab report, or general document, for example.

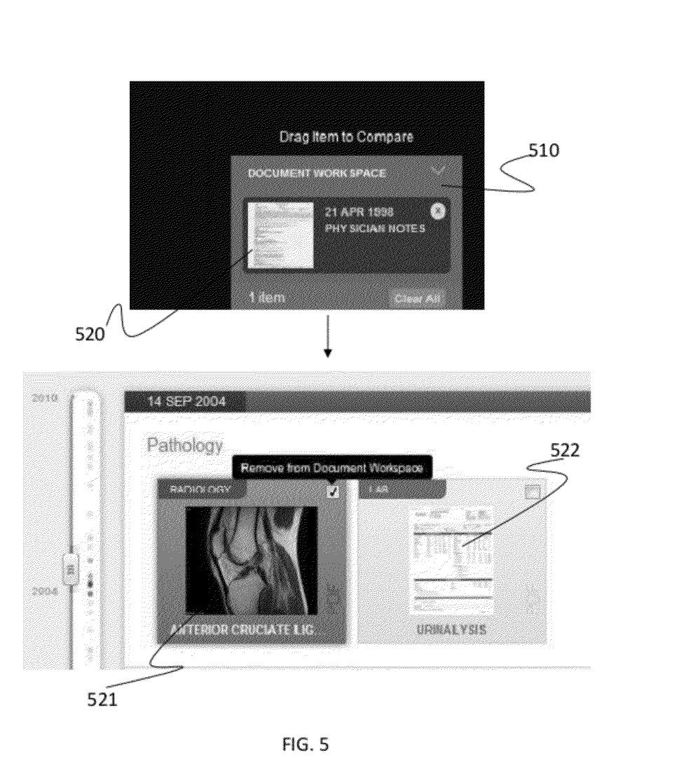

The PIV 100 displays the selected document (e.g., in the viewspace 120). The viewer 100 can provide a name of the document author in addition to the title and date, for example. Upon reading the record, the user may realize that he/she wants to review another document as well. The user can add a record to the document workspace 140, for example. The user can navigate in the viewspace 120 and/or timeline 130 to select another record for review. This record can also be added to the document workspace 140. As illustrated in FIG. 5, one or more items 520-522 can be added, removed, and/or compared via the document workspace 510.

Additionally, document thumbnails that have been selected are highlighted to visually indicate that they have been added to the document workspace 140. This feature reminds physicians what documents in the history view 120 are currently in their workspace 140, for example.

To quickly find relevant encounter(s), physicians can use the timeline 130 to browse the encounter dates along with the types of content in each, which are shown with visual icons, for example. Furthermore, by clicking on a specific date in the timeline 130, the history view 120 can automatically scroll to that encounter, for example.

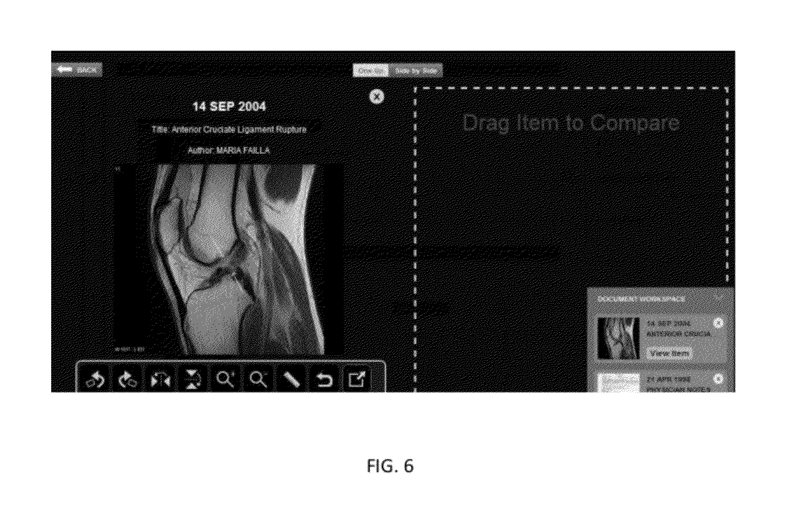

A record/document icon can be selected by the user to jump to a full view of the document, for example. In certain examples, the workspace 510 persists across the two views in order to provide consistency. The user can switch between two or more images by selecting them in the workspace 510 and/or can view the image(s) side-by-side, such as in the example shown in FIG. 3 and discussed above. As illustrated in the example of FIG. 6, by dragging documents into a viewspace, a user can view and make comparisons between the displayed documents. Using the side-by-side view 300 of FIG. 3, a user can review images and/or other documents side-by-side, including descriptive information and toolbars. These toolbars allow the user to rotate, flip, zoom, measure, and/or reset documents, for example. The toolbars can also include an option an external application for additional image manipulation tools, etc.

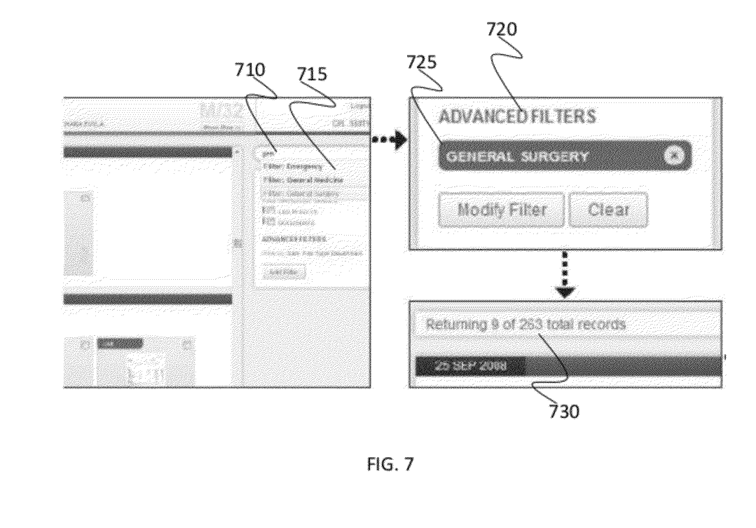

Upon realizing that a large number of encounters are available for review for a patient, the user can decide to search and/or filter for a particular subset of records (e.g., only records from the General Surgery department). As depicted in the example of FIG. 7, typing in the first few letters 710 brings up auto-complete suggestions in a drop-down box 715, for example. Clicking on a suggestion adds General Surgery as a filter 725 in an advanced filters panel 720. A history view is updated to show only encounters from General Surgery, and a bar 730 appears above the history view to show a number of returned results, for example.

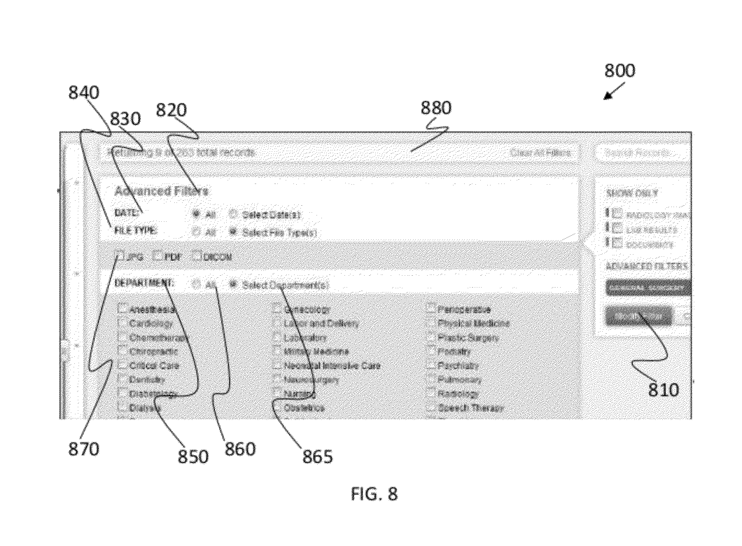

If a user decides that he/she wants to apply some more filters, the user can select a Modify Filter button 810 in a filter panel 800 shown in example FIG. 8. The modify filter button 810 opens an advanced filters panel 820, where the user can select one or more filters including Date 830, File Type 840, Department 850, etc. These filter sections 830, 840, 850 can be expanded by toggling between an “All” option 860 and a “Select Date/File Type/Department(s)” option 865.

As shown in the example of FIG. 8, selecting a checkbox for JPG files 870 also adds another indicator to the filters panel, showing that there are now two filters applied. A status bar 880 above the history view also indicates how many records are being shown.

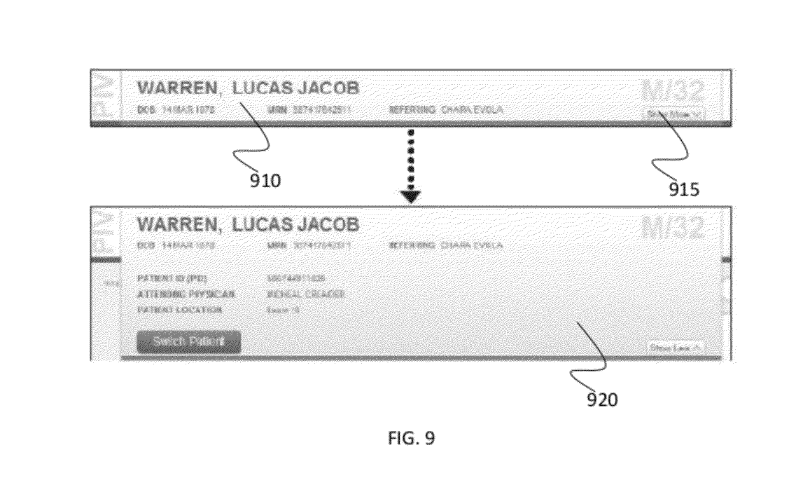

The user reviews the patient's records of the JPG file type from the General Surgery department and decides that he/she wants to contact the patient's attending physician to get further information about the patient's health history. As demonstrated in the example of FIG. 9, while looking for the name of an attending physician, for example, the user may see that general patient information is included in a header 910. Noticing the “Show More” button 915, the user clicks on the button 915 and opens a full header 920. The expanded state header 920 includes additional information, which may otherwise add clutter to the main interface, for example.

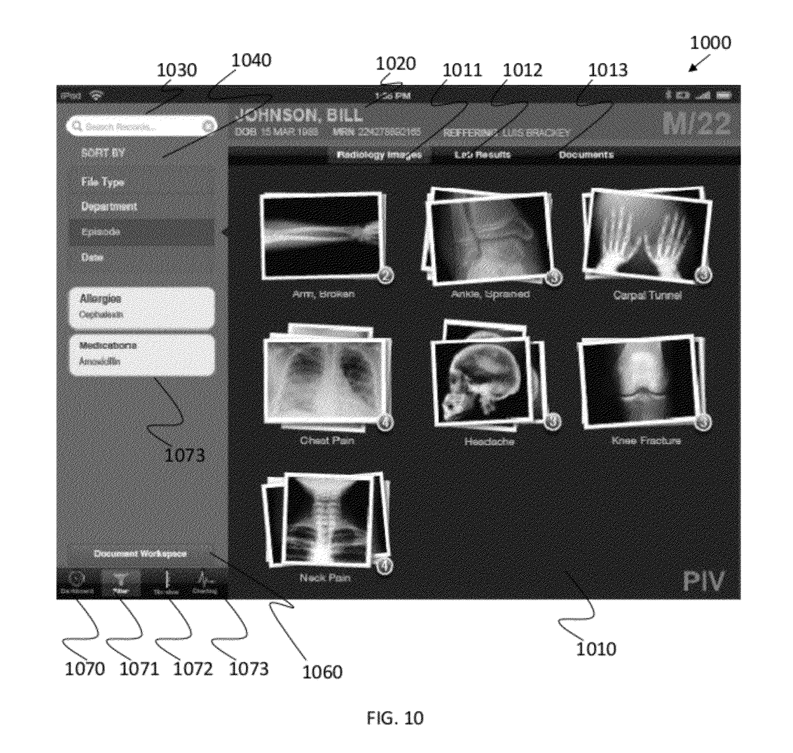

A patient information viewer can be provided in a mobile format 1000 as well. For example, as illustrated in FIG. 10, the PIV 1000 can be provided for access via a tablet computer, such as an Apple iPad™. The mobile PIV 1000 can be provided for access via smartphone and/or other mobile device as well, for example. As illustrated in the example of FIG. 10, the mobile PIV 1000 can include a patient record viewspace 1010. The viewspace 1010 can be subdivided by tabs, for example, to separate images 1011, lab results 1012, and other document 1013.

A header 1020 provides basic identifying information regarding the patient, for example. A search field 1030 allows searching and/or refining of retrieved patient records, for example. Records can be sorted by one or more criterion 1040 including file type, department, episode, date, etc. Key data of interest 1050, such as allergies, medications, etc., can be shown via the example interface 1000.

The example mobile PIV 1000 also includes a document workspace 1060 for document storage for review. Document(s) in the document workspace 1060 can be selected, dragged and dropped, etc., for individual and/or comparison viewing and manipulation in the viewspace 1010, for example. One or more icons can take the user to a dashboard 1070, filter 1071, timeline 1072, charting 1073, and the like.

Using a handheld or mobile device with the mobile Ply 1000 facilitates different workflow(s) by a user who can be accessing information on the move and/or while talking with patient and a user who is sitting in front of a desktop or laptop computer doing documentation and scheduling.

As discussed above, in certain examples, a vertical timeline is provided as part of a patient information viewer on which a patient's encounters are plotted, starting with most recent at the top. This timeline serves two purposes: providing an overview of when patient health issues occurred, and enabling navigation of the patient's records. To accommodate the overview functionality, points on the timeline are semi-transparent so that when the points overlap (e.g., when the patient had numerous records from nearby dates), the points become darker and more apparent compared to isolated visits, which appear lighter. When the user places his or her mouse over the timeline, an expanded view is shown containing details of the visits currently within the selected timeline range. The information shown for each encounter includes the date, the departments from which records exist, and a color coded number corresponding to the type of documents which exist in the record (e.g. radiology images, lab results), for example. Clicking on a record in the expanded timeline view scrolls to that record in the history view (e.g., the viewspace or other the main record browsing component). Upon sliding the timeline, these items update automatically to reflect the new selection.

In certain examples, the timeline selection is based on the size of the browser window (e.g., a number of items which will fit in the expanded view). The date range of the selection can vary depending on the density of encounters, but the number of encounters selected can remain constant so long as the window size does not change.

In certain examples, the timeline pulls all records available from one or more connected systems and plots the records along a vertical timeline, starting with the most recent encounter. Each encounter appears as a semi-opaque marker, with overlapping markers combining opacity to appear darker. In certain examples, upon opening the application, the timeline's expanded view is shown briefly and then closed automatically. When a user hovers his/her mouse over the timeline, the expanded view is again shown.

In certain examples, a selection of the timeline, represented by a blue line to the left of the timeline and blue markers, is determined by the number of items which will fit in the expanded view. The expanded view and blue line are dynamically sized based on the user's browser window, and, thus, a number of items varies with the size of the browser window, for example. In the expanded view, the selected items appear as distinct records including, for example, the date of the encounter, the department(s) from which records originate, and the number of each type of record (radiology images, lab results, and documents). By clicking one of these records, the history view is automatically scrolled to that date.

In certain examples, dragging the timeline slider changes the selected date range and the selected items update accordingly; however, the number of selected items remains the same. The selection thus becomes bigger or smaller based on the density of records over time (e.g. more records in a smaller timespan results in a smaller selection area).

In certain examples, whenever a user is interacting with the timeline (e.g., having the mouse over the timeline area), the expanded view is shown. As soon as the user stops interacting with the timeline (e.g., moves the cursor off the timeline area), the expanded view is closed.

Providing a timeline of patient records allows doctors to more quickly see where in a patient's records exist serious health problems (e.g., clusters of encounters), and more easily allows doctors to browse through records based on dates and, to a lesser extent, departments. The vertical nature of the timeline helps solve the problem of limited vertical space on a standard computer screen. Typical screens are wider than they are tall, and, thus, the example timeline exists to the side of the rest of the content, allowing that content to flow through the entire vertical height of the screen. With a traditional, horizontal timeline, vertical space for the rest of the screen content would have been sacrificed to make it fit above or below.

Using the example timeline, a patient information viewer can provide an at-a-glance view of a patient's medical history. The timeline allows for more easy navigation through records, especially when looking for specific dates. In certain examples, the timeline is implemented using Javascript, which is very accessible. Additionally, the timeline scales to any resolution. Additionally, certain example timelines can be adapted for touch screen use.

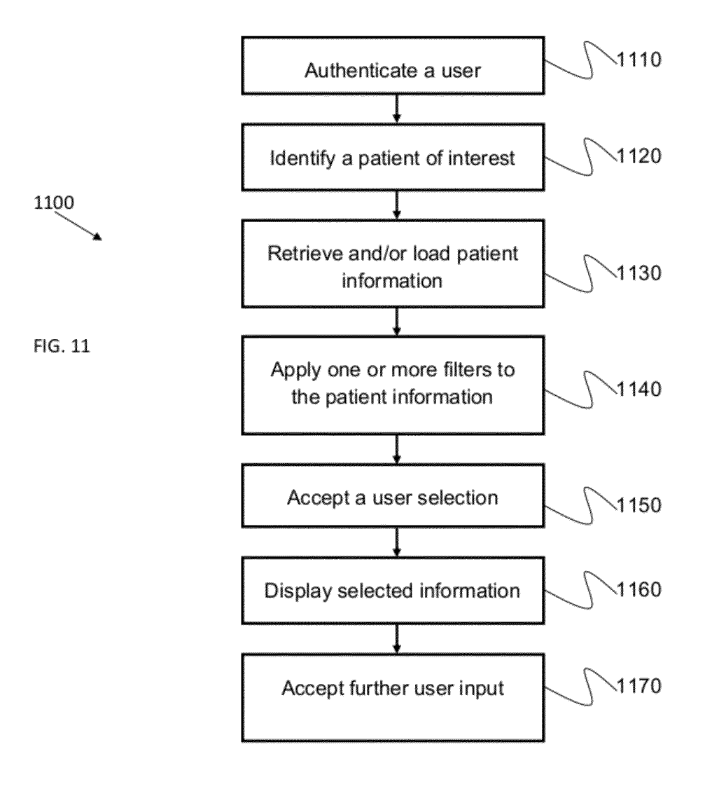

FIGS. 11-14 represent flow and/or dataflow diagrams representative of example machine readable instructions that can be executed to implement the example systems shown in FIGS. 1-10 and/or portions of one or more of those systems. The example processes of FIGS. 11-14 can be performed using a processor, a controller and/or any other suitable processing device. For example, the example processes of FIGS. 11-14 can be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example processes of FIGS. 11-14 can be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIGS. 11-14 can be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 11-14 can be implemented manually or as any combination(s) of any of the foregoing techniques, for example, any combination of firmware, software, discrete logic and/or hardware. Further, although the example processes of FIGS. 11-14 are described with reference to the flow diagrams of FIGS. 11-14, other methods of implementing the processes of FIGS. 11-14 can be employed. For example, the order of execution of the blocks can be changed, and/or some of the blocks described can be changed, eliminated, sub-divided, or combined. Additionally, any or all of the example processes of FIGS. 11-14 can be performed sequentially and/or in parallel by, for example, separate processing threads, processors, devices, discrete logic, circuits, etc.

FIG. 11 illustrates a flow diagram for an example method 1100 for integrated patient information viewing. At block 1110, a user logs in to a patient information viewer system. At block 1120, a patient of interest is identified. For example, a user can identify a patient by name, identification number, and/or other criterion. Patient access can be determined based on user access and/or permission, for example. At block 1130, information regarding the patient is retrieved and/or otherwise loaded with respect to the patient information viewer. For example, historical images, lab results, reports, etc., are retrieved and/or linked from one or more clinical information systems for access via the patient information viewer.

At block 1140, one or more filters can be applied to the patient information via the patient information viewer. For example, information can be filtered by content type, department, date, and/or other custom filter. At block 1150, a user selection is accepted. For example, a timeframe, time entry, document, etc., can be selected by a user from information regarding a patient available via the patient information viewer. At block 1160, selected information is displayed for the user. For example, selected set of documents are displayed in comparison to each other for the user to review. At block 1170, further input is accepted from the user.

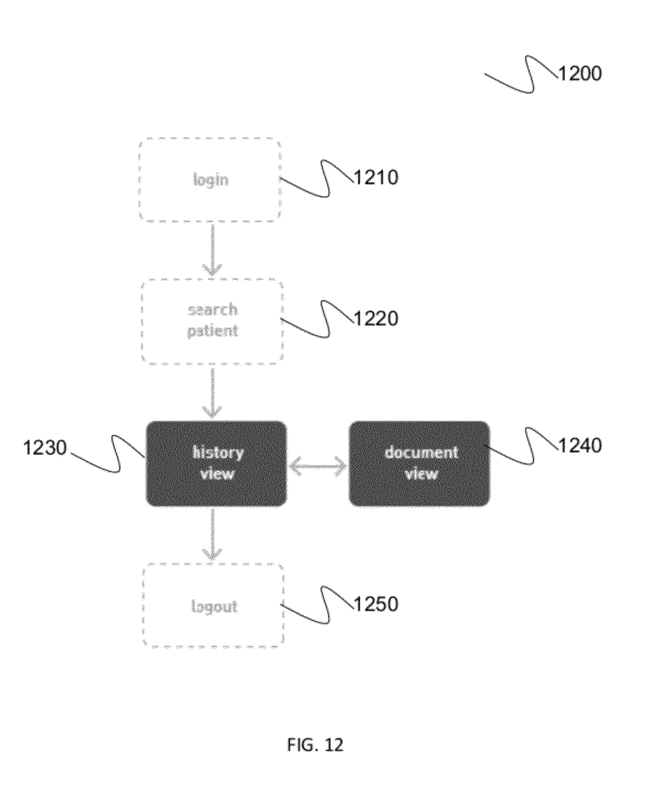

FIG. 12 depicts a patient information system 1200 diagram illustrating relationships between different interface screens and features available in an example patient information viewer. As shown in the example of FIG. 12, a user can login 1210 to access the patient information system 1200. Upon authentication, the user can search 1220 for a particular patient (and/or, in some examples, a group of patients). Upon retrieving records for the patient based on a search, the user can review the results via a patient history view 1230 and/or a patient document view 1240. When the user has completed a review and/or edit of available patient information, the user can logout 1250 of the patient information system 1200.

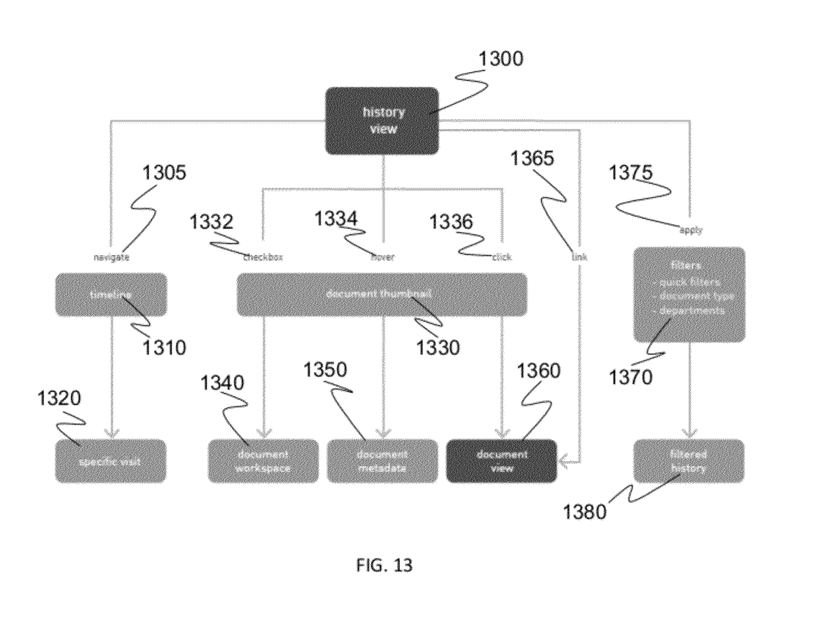

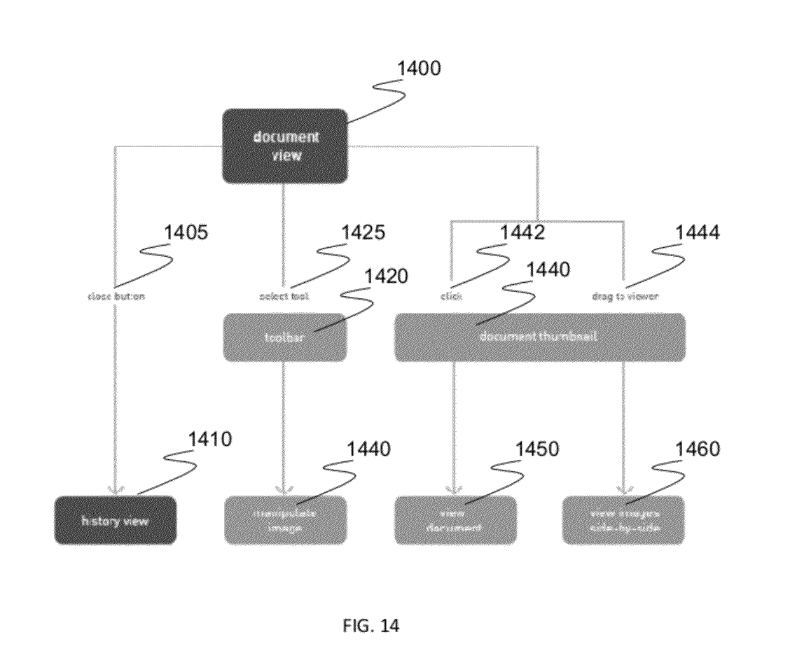

FIGS. 13 and 14 depict interactions that can be performed in a history view (FIG. 13) or document view (FIG. 14), respectively. In the example history view 1300, users can navigate visits and filter patient records that are presented. FIG. 13 also shows example ways in which a user can select one or multiple images. From the example history view 1300, a user can navigate 1305 a timeline 1310 of patient records. From the timeline 1310, the user can select and view a particular visit 1320. The user can interact with a document thumbnail 1330. For example, the user can select a checkbox 1332 with respect to the document thumbnail 1330 to place the document thumbnail 1330 in a document workspace 1340. The user can hover 1334 over the document thumbnail 1330 to view document metadata 1350 (e.g., summary information about the document), for example. The user can click or select 1336 the document thumbnail 1330 to view the document in a document view 1360, for example. The history view 1300 can link 1365 to the document view 1360 (shown, for example, as the document view 1400, discussed further below). Within the history view 1300, the user can also apply 1375 one or more filters 1370 to the patient records to provide a filtered history 1380 for the patient, for example.

In the example document view 1400 shown in FIG. 14, users can change the arrangement of images, use tools to manipulate images and/or other documents, and/or navigate back to the history view 1300, for example. Within the document view 1400, a user can close 1405 the document view 1400 and return to a history view 1410 (such as the history 1300 discussed above). The user can select a tool 1425 from a toolbar 1420 associated with the document view 1400 to manipulate an image 1430, for example. The user can interact with a document thumbnail 1440 via the document view 1400. For example, the user can click on or otherwise select 1442 the document thumbnail 1440 to view the actual document 1450 represented by the thumbnail or miniature representation 1440. The user can drag 1444 the document thumbnail 1440 to a viewing area to view images side-by-side 1460, for example.

In certain examples, a user can log in directly to a PIV. In certain examples, a user can access a PIV via an EMR and/or other healthcare application, and launch the PIV from that application. Rather than accessing several different programs to view patient information, the PIV provides a more comprehensive view of a patient's health record and related information accessible via an integrated viewer interface. In certain examples, information for a patient is organized based on relevance, recency, and severity to help a user find the most salient information in a patient's medical history. Additionally, the PIV can provide users with one or more mechanisms to customize the granularity of data shown, as well as highlighting relevant information. Color coding and information placement, for example, can further aid in helping to ensure that important data is easily seen. Further, the PIV helps to ensure that information needed by doctors is available and readily accessible. By addressing real-world needs and workflows of healthcare practitioners, the PIV can be both usable and desirable. An additional benefit to improved usability is a reduced need for training to use the system.

Additionally, by making interface(s) intuitive and portable, healthcare practitioners can meet with patients face-to-face with knowledge of relevant information regarding the patient's visit, which helps provide high quality care to patients. Further, patient-facing information can also help alleviate fears of seeming distracted as a doctor, nurse, etc., can then include the patient in the interaction.

Thus, certain examples provide a patient information viewer including a plurality of user interface components interacting with one another to provide content and tools to a user with respect to a patient's records. The user interface is divided into several main component views that closely interact including a patient header, timeline, history view, document viewer, and filter components, for example. Furthermore, some of these components have sub-components that aid in their function. For example, the viewer benefits from a persistent document workspace, which is able to store and/or mark several different types of documents for viewing in the viewer.

By intelligently displaying the components, and managing their size within the user interface, the user is able to see a fuller picture of the patient's information in one place. User interface examples presented here help to balance the importance of different information to represent the most important data upfront. Furthermore, example user interfaces take into account the dimensions of the user's monitor and browser size, and help to optimize or improve user interface component placement and dimensions.

In certain examples, the patient header is dynamic and expands upon a user's mouse over and/or selection. When expanded, the header is able to show more comprehensive information about the patient and can obscure portions of the user interface below it, for example. The timeline is also dynamic, and expands when the user directly interacts with it. The timeline can obscure portions of the history view when it is expanded, for example.

The history view includes retrieved patient records in a long scrolling list. Clicking an individual item can launch the document viewer with that item opened. Alternatively, selecting a checkbox in the corner of a record item, for example, can add that item to the document workspace. The document workspace lives at the edge of the user interface screen and automatically expands when documents are added to it, for example. The document workspace component can grow in vertical height until it covers a pre-determined amount of space in a filters component of the user interface, at which point the contents of the document workspace can scroll vertically, for example.

In certain examples, the viewer is a modal overlay, which covers all of the screen elements aside from the header and document workspace. These components can have a higher z-index to be on top of the viewer, for example. The filters component includes a filter bar (e.g., positioned on the right hand of the main user interface screen), as well as an advanced filters component user interface. In certain examples, both interfaces expand as necessary to display included content. The advanced filters user interface can also hide unnecessary items until their corresponding radio buttons are selected, for example.

Healthcare practitioners, such as doctors and nurses, use a wide array of devices with various screen sizes. By creating an effective layout and integrating individual components, user interface content can be adapted to fit the available screen size. In certain examples, space efficiency is observed by forming user interface components to occupy a fraction of the space they normally would when the user interface component is not being directly interacted with (for example, the timeline).

Thus, certain examples provide an easy-to-use, well-integrated (e.g., imaging and patient information coincide), fast-loading, efficient, and differentiated patient information viewer system and associated method of use. In certain examples, the PIV is based in HTML5 and can be viewed on many platforms. Such a PIV is easily distributable, easily scalable, easily developed, and easily configured, for example. Certain examples include several user interface components integrated in a patient information viewer. The components automatically resize, appear and hide to form a “smart” user interface. In certain examples, components change size based on user actions (e.g., mouse over events, etc). In certain examples, components transcend different user interface states to reduce or minimize the disruption of screens across the user interface (e.g. the document workspace and header) and to increase or maximize user awareness of the components.

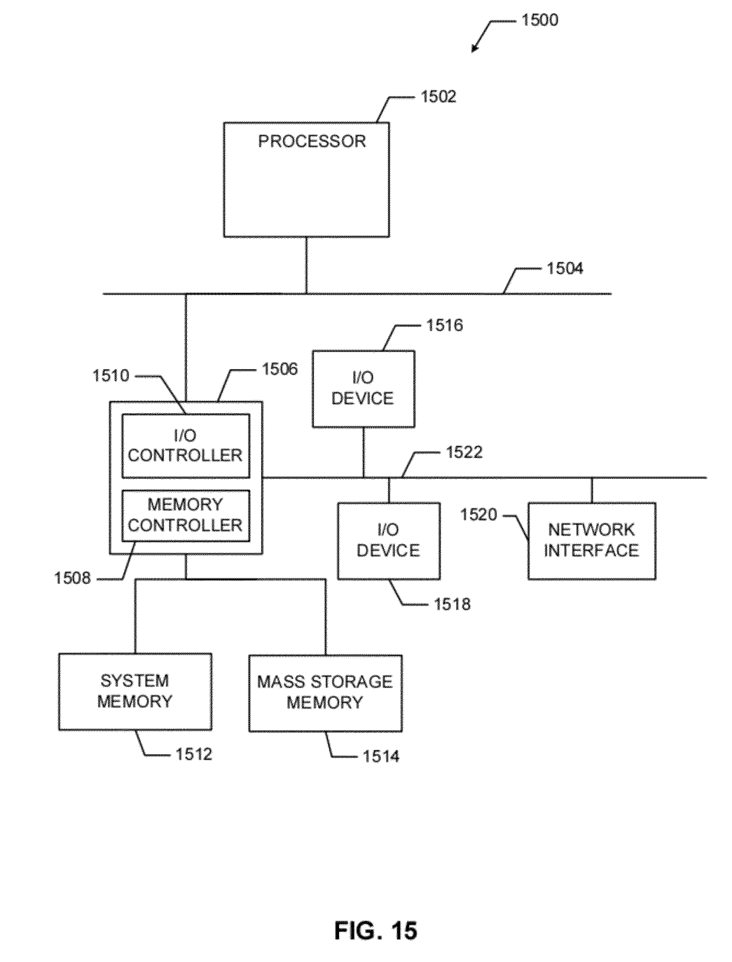

FIG. 15 is a block diagram of an example processor system 1510 that can be used to implement systems, apparatus, and methods described herein. As shown in FIG. 15, the processor system 1510 includes a processor 1512 that is coupled to an interconnection bus 1514. The processor 1512 can be any suitable processor, processing unit, or microprocessor, for example. Although not shown in FIG. 15, the system 1510 can be a multi-processor system and, thus, can include one or more additional processors that are identical or similar to the processor 1512 and that are communicatively coupled to the interconnection bus 1514. For example, “cloud” and/or “grid” based computing can be employed for three dimensional processing using Euclidian vectors and linear algebra, as described above. In certain examples, a Bayesian algorithm can be used in an evolving model combining multiple executions of multiple algorithms. As certain mappings are resolved, a probability associated with other remaining mappings changes.

The processor 1512 of FIG. 15 is coupled to a chipset 1518, which includes a memory controller 1520 and an input/output (“I/O”) controller 1522. As is well known, a chipset typically provides I/O and memory management functions as well as a plurality of general purpose and/or special purpose registers, timers, etc. that are accessible or used by one or more processors coupled to the chipset 1518. The memory controller 1520 performs functions that enable the processor 1512 (or processors if there are multiple processors) to access a system memory 1524 and a mass storage memory 1525.

The system memory 1524 can include any desired type of volatile and/or non-volatile memory such as, for example, static random access memory (SRAM), dynamic random access memory (DRAM), flash memory, read-only memory (ROM), etc. The mass storage memory 1525 can include any desired type of mass storage device including hard disk drives, optical drives, tape storage devices, etc.

The I/O controller 1522 performs functions that enable the processor 1512 to communicate with peripheral input/output (“I/O”) devices 1526 and 1528 and a network interface 1530 via an I/O bus 1532. The I/O devices 1526 and 1528 can be any desired type of I/O device such as, for example, a keyboard, a video display or monitor, a mouse, etc. The network interface 1530 can be, for example, an Ethernet device, an asynchronous transfer mode (“ATM”) device, an 802.11 device, a DSL modem, a cable modem, a cellular modem, etc., that enables the processor system 1510 to communicate with another processor system.

While the memory controller 1520 and the I/O controller 1522 are depicted in FIG. 15 as separate blocks within the chipset 1518, the functions performed by these blocks can be integrated within a single semiconductor circuit or can be implemented using two or more separate integrated circuits.

Certain embodiments contemplate methods, systems and computer program products on any machine-readable media to implement functionality described above. Certain embodiments can be implemented using an existing computer processor, or by a special purpose computer processor incorporated for this or another purpose or by a hardwired and/or firmware system, for example.

Some or all of the system, apparatus, and/or article of manufacture components described above, or parts thereof, can be implemented using instructions, code, and/or other software and/or firmware, etc. stored on a machine accessible or readable medium and executable by, for example, a processor system (e.g., the example processor system 1510 of FIG. 15). When any of the appended claims are read to cover a purely software and/or firmware implementation, at least one of the components is hereby expressly defined to include a tangible medium such as a memory, DVD, CD, Blu-ray disc, etc. storing the software and/or firmware.

Thus, certain examples described herein facilitate use of reduced manpower associated with manually matching terms between two or more code schemes, as well as helping to provide faster interoperability configuration. Certain examples provide more reliable concept matching by computer-generated determination of match probabilities augmented by user confirmation. Certain examples provide both alphanumeric and graphical representations of likely concept matches for both automated and manual review and confirmation of a probable concept match. Certain examples provide technical effects of advanced analytics, real-time decision support, and business intelligence through use of structured, coded data. Certain examples help reduce costs incurred due to redundant and disparate data definition, storage, and maintenance and help promote national and international interoperability by sharing terminology with the healthcare community at large.

Certain embodiments contemplate methods, systems and computer program products on any machine-readable media to implement functionality described above. Certain embodiments can be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media can be any available media that can be accessed by a general purpose or special purpose computer or other machine with a processor. By way of example, such computer-readable media can include RAM, ROM, PROM, EPROM, EEPROM, Flash, CD-ROM, DVD, Blu-ray or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions include, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention can be practiced in a networked environment using logical connections to one or more remote computers having processors. Logical connections can include a local area network (LAN) and a wide area network (WAN) that are presented here by way of example and not limitation. Such networking environments are commonplace in office-wide or enterprise-wide computer networks, intranets and the Internet and can use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention can also be practiced in distributed computing environments where tasks are performed by local and remote processing devices that are linked (either by hardwired links, wireless links, or by a combination of hardwired or wireless links) through a communications network. In a distributed computing environment, program modules can be located in both local and remote memory storage devices.

While the invention has been described with reference to certain embodiments, it will be understood by those skilled in the art that various changes can be made and equivalents can be substituted without departing from the scope of the invention. In addition, many modifications can be made to adapt a particular situation or material to the teachings of the invention without departing from its scope. Therefore, it is intended that the invention not be limited to the particular embodiment disclosed, but that the invention will include all embodiments falling within the scope of the appended claims.

1. An integrated patient information viewer system comprising:
a header portion to be arranged to convey identification information for a patient to a user at a glance;
a timeline arranged to provide a longitudinal visualization of a patient's record, the timeline to be navigable to display different portions of the patient's record based on user input, the timeline to provide visual indicators of clusters of patient encounters, the timeline to expand to provide further detail on a patient encounter based on user input;
a user viewspace to display a chronological view of patient encounters and associated documents, the viewspace to enable a user to one or more documents for display and comparison; and
a document workspace to store one or more patient documents based on user placement, the one or more patient documents to be retrievable for display and comparison in the user viewspace,
wherein a change in information presented in one of the timeline, the user viewspace, or the document workspace is to affect a corresponding change in information presented in the other of the timeline, the user viewspace, or the document viewspace.

2. The system of claim 1, wherein the header is to be displayed in a collapsed form and is to be expanded to an extended header including additional information related to the patient.

3. The system of claim 1, wherein the viewspace includes a dashboard to provide an at-a-glance view of patient status and patient data organized by at least one of recency and relation to a current complaint of the patient, the dashboard to provide access to at least one of vitals, images, and labs for the patient.

4. The system of claim 1, wherein the viewspace includes a document view, the document view to enable viewing of a single document and viewing of multiple documents side by side in the viewspace.

5. The system of claim 4, wherein the document view provides a toolset for manipulation of one or more documents in the document view.

6. The system of claim 1, wherein the timeline is to provide an expanded view of one or more encounters including a date, a type of each document associated with the encounter, a number of documents of each type associated with the encounter, and a department associated with each document associated with the encounter, each document to be selectable from the timeline for review in the viewspace.

7. The system of claim 1, further comprising a filter to reduce patient records provided for viewing in the viewspace, the filter including a plurality of filters selectable by the user.

8. The system of claim 7, wherein the filter further comprises a filter search to identify one or more applicable filters for use by the user to reduce the patient records provided for viewing.

9. The system of claim 1, wherein the patient information viewer system comprises a mobile device.

10. A tangible computer readable storage medium including executable program instructions which, when executed by a computer processor, cause the computer to implement a patient information viewer, the patient information viewer comprising:
a header portion to be arranged to convey identification information for a patient to a user at a glance;
a timeline arranged to provide a longitudinal visualization of a patient's record, the timeline to be navigable to display different portions of the patient's record based on user input, the timeline to provide visual indicators of clusters of patient encounters, the timeline to expand to provide further detail on a patient encounter based on user input;
a user viewspace to display a chronological view of patient encounters and associated documents, the viewspace to enable a user to one or more documents for display and comparison; and
a document workspace to store one or more patient documents based on user placement, the one or more patient documents to be retrievable for display and comparison in the user viewspace,
wherein a change in information presented in one of the timeline, the user viewspace, or the document workspace is to affect a corresponding change in information presented in the other of the timeline, the user viewspace, or the document viewspace.

11. The computer readable storage medium of claim 10, wherein the header is to be displayed in a collapsed form and is to be expanded to an extended header including additional information related to the patient.

12. The computer readable storage medium of claim 10, wherein the viewspace includes a dashboard to provide an at-a-glance view of patient status and patient data organized by at least one of recency and relation to a current complaint of the patient, the dashboard to provide access to at least one of vitals, images, and labs for the patient.

13. The computer readable storage medium of claim 10, wherein the viewspace includes a document view, the document view to enable viewing of a single document and viewing of multiple documents side by side in the viewspace.

14. The computer readable storage medium of claim 13, wherein the document view provides a toolset for manipulation of one or more documents in the document view.

15. The computer readable storage medium of claim 10, wherein the timeline is to provide an expanded view of one or more encounters including a date, a type of each document associated with the encounter, a number of documents of each type associated with the encounter, and a department associated with each document associated with the encounter, each document to be selectable from the timeline for review in the viewspace.

16. The computer readable storage medium of claim 10, further comprising a filter to reduce patient records provided for viewing in the viewspace, the filter including a plurality of filters selectable by the user.

17. The computer readable storage medium of claim 16, wherein the filter further comprises a filter search to identify one or more applicable filters for use by the user to reduce the patient records provided for viewing.

18. A computer-implemented method for providing an integrated patient information view to a user, the method comprising:
authenticating a user for access to healthcare records for a selected patient;
providing a plurality of records for the patient to the user via an integrated patient information viewer, the patient information viewer including:
a header portion to be arranged to convey identification information for a patient to a user at a glance;
a timeline arranged to provide a longitudinal visualization of a patient's record, the timeline to be navigable to display different portions of the patient's record based on user input, the timeline to provide visual indicators of clusters of patient encounters, the timeline to expand to provide further detail on a patient encounter based on user input;
a user viewspace to display a chronological view of patient encounters and associated documents, the viewspace to enable a user to one or more documents for display and comparison; and
a document workspace to store one or more patient documents based on user placement, the one or more patient documents to be retrievable for display and comparison in the user viewspace,
wherein a change in information presented in one of the timeline, the user viewspace, or the document workspace is to affect a corresponding change in information presented in the other of the timeline, the user viewspace, or the document viewspace;
accepting user selection to display one or more records in the user viewspace based on user input from at least one of the timeline, user viewspace, and document workspace.

19. The method of claim 18, further comprising facilitating a display and comparison of a plurality of selected documents side by side in the user viewspace.

20. The method of claim 18, further comprising providing an expanded view of one or more encounters in the timeline including a date, a type of each document associated with the encounter, a number of documents of each type associated with the encounter, and a department associated with each document associated with the encounter, wherein each document is selectable from the timeline for review in the viewspace.

21. The method of claim 18, further comprising filtering to reduce patient records provided for viewing in the viewspace, the filter including a plurality of filters selectable by the user.
